(19) United States
(12) Patent Application Publication
(10) Pub. No.: US 2008/0000701 A1
(43) Pub. Date: Jan. 3, 2008

(54) Method of controlling the operating mode of a hybrid motor vehicle

(76) Inventors: Norbert Ebner, Ludwigsburg (DE); Heiko Mayar, Adelmannsfelden (DE)

Correspondence Address: KLAUS J. BACH, 4407 TWIN OAKS DRIVE, MURRYSVILLE, PA, 15668, US

(21) Appl. No.: 11/800,006

(22) Filed: May 1, 2007

Related U.S. Application Data
(63) Continuation-in-part of application No. PCT/EP05/11536, filed on Oct. 28, 2005.

(30) Foreign Application Priority Data
Nov. 9, 2004 (DE) 10 2004 053 948.0

(51) Int. Cl. B60K 6/00

(52) U.S. Cl. 180/65.2; 903/940

(57) ABSTRACT

In a method for controlling the operating mode of a vehicle with hybrid drive, wherein the operating mode is defined by a number of drive types including an internal combustion engine drive, an electromotive drive and a mixed drive, a control device for selecting an appropriate operating mode for optimum comfort and consumption is provided, the selection of the operating mode being limited and dependent on the momentary operating mode permitting only specific changes between the operating modes.

This is a Continuation-in-Part Application of pending International Patent Application PCT/EP2005/011536 filed Oct. 28, 2005 and claiming the priority of German Patent Application 10 2004 053 948.0 filed Nov. 9, 2004.

### BACKGROUND OF THE INVENTION

The invention relates to a method of controlling the operating mode of a hybrid motor vehicle, wherein the operating mode is determined by at least one of the drive types comprising an internal combustion engine, an electric motor and a mixed drive, and to a control device for selecting the operating mode.

DE 100 35 027 A1 discloses a method for controlling the operating mode of a vehicle with hybrid drive in which the operating mode is controlled as a function of the profile of the route on which the vehicle is traveling, the sensed vehicle movement dynamics, the sensed driver behavior and/or the available electric drive power.

In vehicles having a plurality of drive trains such as, for example, in vehicles with hybrid drive, there is the problem that when the operating mode changes, the drive train torque or the moment of mass inertia changes, thus bringing about a jolt in the drive train. This jolt is perceived negatively by the driver of a vehicle.

It is the object of the present invention to provide a method of controlling the operating modes of a vehicle with hybrid drive, in particular the changes between the operating modes, in such a way that optimum comfort and fuel consumption are achieved.

### SUMMARY OF THE INVENTION

In a method for controlling the operating mode of a vehicle with hybrid drive, wherein the operating mode is defined by a number of drive types including an internal combustion engine drive, an electromotive drive and a mixed drive, a control device for selecting an appropriate operating mode for optimum comfort and consumption is provided, the selection of the operating mode being limited and dependent on the momentary operating mode permitting only specific changes between the operating modes.

Changes are made possible only between operating modes in which the involved drive train components, for example an internal combustion engine and a first and second electric motor, can be pilot-controlled independently of one another in terms of rotational speed and torque before the change. As a result, no changes in torque arise when the drive train components are connected to, and disconnected from, the output, and there is thus also no jolt in the drive train. Since these changes therefore do not bring about any adverse effect on the comfort, the frequency of the changes does not need to be reduced, for example by hysteresis, but rather it is always possible to select the optimum operating mode in terms of consumption and comfort.

The invention will become more readily apparent from the following description of exemplary embodiments of the invention described in more detail below with reference to the accompanying drawings:

### BRIEF DESCRIPTION OF THE DRAWINGS

FIG. 1 shows the preferred operating modes of a vehicle with hybrid drive and the possible changes between the operating modes, and

FIG. 2 shows schematically a vehicle with hybrid drive.

### DETAILED DESCRIPTION OF THE INVENTION

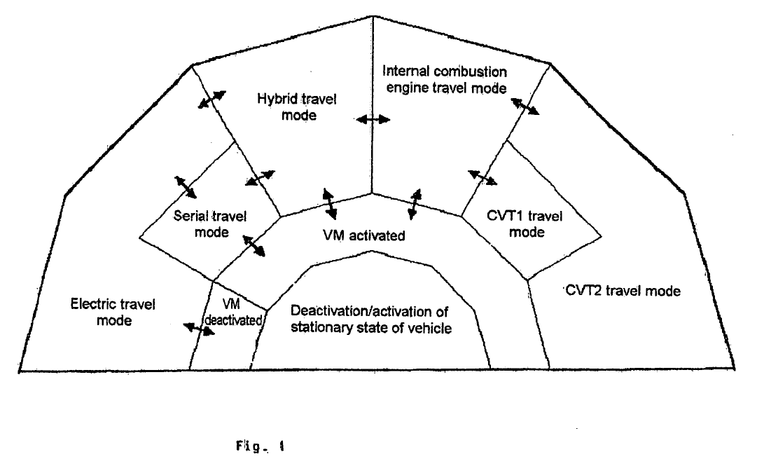

FIG. 1 shows the preferred operating modes of a vehicle with hybrid drive and the possible changes, characterized by arrows, between the operating modes. Furthermore, the possible changes when the vehicle is in the stationary state and the internal combustion engine is activated or deactivated are illustrated. This exemplary embodiment has two CVT travel modes, the CVT1 travel mode and the CVT2 travel mode, in which the vehicle is driven by means of an infinitely variable transmission ratio, for two different driving ranges. The first driving range is preferably assigned to a speed from −30 km/h to +75 km/h. In this context, the maximum gearbox output torque is, for example, 1300 Nm, in particular in the range between 10 km/h and 40 km/h. The second driving range is preferably assigned to higher velocities. The maximum gearbox output torque is lower than in the first driving range, for example 440 Nm in the range between 50 km/h and 250 km/h.

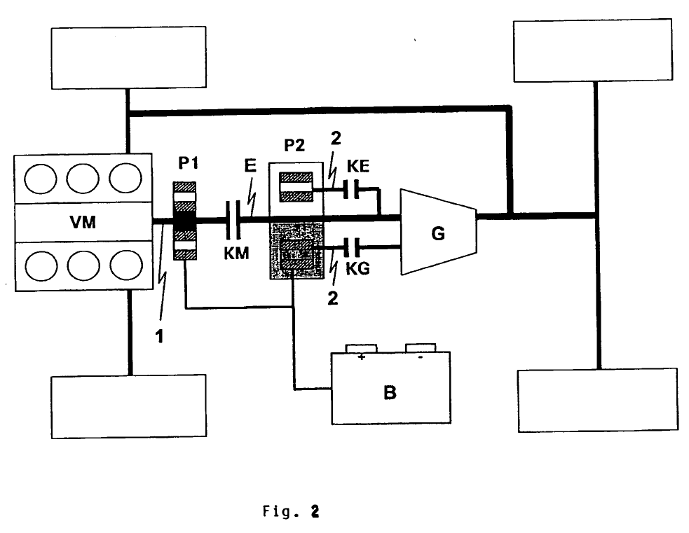

The drive train of the vehicle illustrated in FIG. 2 has an electric motor P1 and an electric motor P2. The electric motor P1 has a stator which is fixed to the housing and which interacts with a rotor to generate a drive torque and/or to recover electrical energy. The rotor is connected fixedly in terms of drive to a motor shaft 1 so that a torque can be fed into the drive train by means of the electric motor P1 in addition to an internal combustion engine VM, or else a torque which is present in the drive train can be used (at least partially) to recover electrical energy.

The electric motor P2 has a stator and a rotor. The stator is connected fixedly to the housing while the rotor has a drive connection to an intermediate shaft 2 which has two clutches KE and KG. The intermediate shaft 2 can be connected directly to an input shaft E by means of the clutch KE.

The intermediate shaft 2 can be connected directly to the sun gear of a summing gear mechanism G via the clutch KG.

The motor shaft 1 can be connected directly to the input shaft E via a clutch KM.

The clutch KM can be a dry clutch or wet clutch with partial or complete starting functionality. If the clutch KM is overloaded, the load can be lessened by starting without this clutch KM by means of an electric motor.

The electric motors P1 and P2 are fed by a battery B. The electric motors P1 and P2 are acted on and operated by a control device according to the invention in order to select the operating mode. The control device acts on or interacts with a further control device for clutches and brakes of the drive train. It is also possible to interact with other control devices, in particular for the internal combustion engine VM.

The electric motor P2 is preferably a high-torque slow rotor, while the electric motor P1 supplies a relatively low torque at high rotational speeds.

For the starting of the internal combustion engine VM it is possible to differentiate between the cases of a warm start, cold start and extreme start.

For a warm start of the internal combustion engine VM, said internal combustion engine is turned over by means of the electric motor P1, which outputs power in this case. The rotational speed of the internal combustion engine VM is between zero and the idling speed.

The clutches KM, KE and KG are in the nonactivated state.

For a cold start of the internal combustion engine VM, the internal combustion engine is turned over by means of a combination of the electric motors P1 and P2, during which time the electric motors P1 and P2 output power. The rotational speed of the internal combustion engine VM and thus of the electric motor P2 is between zero and the idling speed. For this operating state the clutches KM and KE are activated, while the clutch KG is not activated.

For an extreme start of the internal combustion engine VM, the internal combustion engine VM is operated by both electric motors P1 and P2, in which case the summing gear mechanism G is connected therebetween in such a way that the output torque of the electric motor P2 is increased in the direction of the internal combustion engine VM. The electric motor P2 is operated for this operating state with a relatively high rotational speed of the internal combustion engine VM, in particular with twice the rotational speed, obtained by the transmission ratios. In such an extreme start, the clutches KM and KG are activated, while the clutch KE is deactivated.

In the operating modes of the electric travel mode and serial travel mode which are illustrated in FIG. 1, the preferred vehicle as it is shown in FIG. 2 is driven by the electric motor P2 by means of the activated clutch KE.

In the operating mode “electric drive”, the clutches KM and KG and the internal combustion engine VM and the electric motor P1 are deactivated. Starting and driving are carried out by suitable energization of the electric motor P2, in which case the latter either supplies a drive torque or feeds power into the battery B in the generator operating mode.

In the operating mode of the “serial drive”, the clutches KM and KG are deactivated. The internal combustion engine VM is activated and drives the electric motor P1 via the motor shaft 1 in the generator operating mode so that the latter feeds power into the battery B. This permits the load on the battery B to be lessened and/or operation to be prolonged when the battery B is acted on. The electric motor P2 either supplies via the intermediate shaft 2 a drive torque or, in the generator operating mode, feeds power into the battery B.

In the operating modes “hybrid drive” and “internal combustion engine drive”, the clutch KM and the internal combustion engine VM are activated. The clutch KG is deactivated.

If the clutch KE is activated in the operating mode “hybrid drive”, a first power branch with the torque of the internal combustion engine VM extends via the motor shaft 1 and the clutch KM, possibly with a transfer of power to or from the electric motor/generator P1. A second power branch extends via the electric motor P2 and the intermediate shaft 2. The two power branches are joined via the clutch KE so that the input shaft E which is connected downstream in the force flux is acted on as a result of the superimposition of the drive torques of the first and second power branches. Owing to the closed clutch KE, the rotational speeds of the input shaft E, intermediate shaft 2, clutch KM and possibly electric motor P1 and internal combustion engine VM are identical.

When the power demand is at a maximum, drive is provided by means of the internal combustion engine VM and both electric motors P1 and P2.

It is also possible for drive to be provided either via the internal combustion engine VM and the electric motor P1, while the electric motor P2 is operated in the generator operating mode, or drive is provided only via the internal combustion engine VM and both electric motors P1 and P2 are operated in the generator operating mode. This permits the load on the battery B to be lessened and/or operation to be prolonged when battery B power is used.

In the operating mode of the internal combustion engine drive mode, the clutch KE and the electric motor P2 are deactivated. When the clutches KE and KG are deactivated, the drag losses of the electric motor P2 can be kept low. The electric motor P2 is coupled only to the drive train when absolutely necessary.

By suitably energizing the electric motor P1 it is possible to supply a supplementary torque, in particular for supporting the drive or warming up, or else energy can be recovered in a generator operating mode of the electric motor P1. This is done in particular during a normal travel mode or during a braking phase of the motor vehicle.

If an increased power demand is not present and there is also no need for energy recuperation by means of the electric motor P1, drive power is provided exclusively by means of the internal combustion engine VM.

In an operating mode of the CVT travel mode the clutches KM and KG are activated while the clutch KE is deactivated.

A first power branch extends from the internal combustion engine VM via the motor shaft 1, the clutch KM, the input shaft E and possibly with an exchange of power with the electric motor P1, while a second power branch extends from the electric motor P2 via the intermediate shaft 2 and the clutch KG. The two power branches are superimposed in the summing gear mechanism G in which a ring gear is coupled to the first power branch, and the sun gear is coupled fixedly in terms of drive to the second power branch. As a result of the combination by means of the summing gear mechanism G, the first power branch and the second power branch can be operated at different rotational speeds.

The output of the summing gear mechanism G is via the planetary gear carrier. The superimposition by means of the summing gear mechanism G produces a variable transmission ratio in the direction of the output element.

In this way it is possible, for example, to implement what is referred to as a geared neutral function which ensures a stationary state of the vehicle. In this state, the internal combustion engine VM is operated with a rotational speed which is higher than or equal to the idling speed. The electric motor P1 can then supply a positive or negative output torque. In this state, the electric motor P2 rotates at a rotational speed which corresponds to the geared neutral point. The output torque of the electric motor P2 is also in a fixed ratio, predetermined by the geometric ratios of the planetary gear set, to the torque which is applied to the planetary gear set via the ring gear on the input shaft E by the internal combustion engine VM and the electric motor P1. The necessary rotational speed of the electric motor P2 for the geared neutral point is produced from the ratio of the diameter of the sun gear with respect to the diameter of the ring gear.

When the clutches and brakes have an unchanged position, forward or rearward travel is produced in order to reduce or increase the rotational speed of the electric motor P2.

The CVT travel modes of CVT1 travel mode and CVT2 travel mode which are specified in the exemplary embodiment for the two different driving ranges which are explained differ in the method of power transmission from the summing gear mechanism G to a partial gear mechanism (not illustrated) which is connected downstream and which is embodied as an automatic transmission, and in the transmission ratio in the partial gear mechanism which is connected downstream. This is implemented by means of differently connected clutches or brakes in the partial gear mechanism which is connected downstream.

By means of the abovementioned, different operating modes of the vehicle it is possible to achieve identical or comparable driving states of the vehicle in different ways.

A target operating mode which is suitable for a desired driving state is selected, for example, by means of a characteristic diagram which contains, for example, efficiency levels, power balances, achievable acceleration values or the like. Alternatively or additionally it is possible to monitor individual operating variables of the drive train such as operating temperatures of the electric motors P1 and P2 or clutches and brakes so that when a limit value of an operating temperature is exceeded a clutch can be deactivated by changing an operating mode so that the load on the latter or on an assigned electric motor is lessened. Alternatively or additionally it is possible, when selecting the target operating mode, to take into account the load state of a battery B which serves to energize the electric motors P1 and P2. Further criteria for selecting the target operating mode can be the profile of the route on which the vehicle is traveling, the sensed vehicle movement dynamics and/or the sensed driver behavior. A suitable target operating mode can also be selected, for example, according to an operating strategy which is predefined on a priori basis.

If a suitable target operating mode has been selected and the control device permits the change from the current operating mode to the target operating mode, the system is changed to the target operating mode. If this change is not possible, a change into another operating mode may possibly be carried out firstly and a change to the target operating mode is then made possible from this operating mode, or another target operating mode can be selected.

The control device only permits changes between operating modes in which the involved drive train components have to be pilot-controlled independently of one another in terms of rotational speed and torque before the change. As a result, when the drive train components are connected to, and disconnected from, the output, there are no changes in torque and thus also no jolt in the drive train occurs. Since comfort is therefore not adversely affected by these changes, the frequency of the changes does not need to be reduced, for example by hysteresis, but rather it is always possible to select the operating mode which is the optimum one in terms of consumption and comfort.

In the exemplary embodiment illustrated in FIG. 1, changes between the following operating modes are possible:
serial travel mode and electric travel mode,
serial travel mode and hybrid travel mode,
electric travel mode and hybrid travel mode,
hybrid travel mode and internal combustion engine travel mode, and
internal combustion engine travel mode and CVT1 travel mode or CVT2 travel mode.

If the vehicle is in the electric operating mode and the target operating mode of the internal combustion engine travel mode has been selected, a change into the hybrid travel mode occurs firstly and then a change into the internal combustion engine travel mode occurs. If the system is to be changed from the electric travel mode into the CVT1 travel mode or CVT2 travel mode, this is done via the intermediate steps of the hybrid travel mode and internal combustion engine travel mode. The changes in the opposite direction occur in an analogous fashion.

Changes out of or into the serial travel mode or into or out of the internal combustion engine travel mode or CVT1 travel mode or CVT2 travel mode are carried out in a corresponding fashion.

For changes between the CVT1 travel mode and CVT2 travel mode as well as between the hybrid travel mode and CVT1 travel mode or CVT2 travel mode, the system is firstly changed into the internal combustion engine travel mode. When there is a change from the electric travel mode to the serial travel mode, the internal combustion engine VM is activated and the electric motor P1 is operated in the generator operating mode. The electric motor P1 supplies energy for the on-board electrical system and the electric motor P2. The internal combustion engine VM is operated in a way which provides for lowest possible consumption.

When there is a change from the serial travel mode to the electric travel mode, the internal combustion engine VM and the electric motor P1 are deactivated.

When there is a change from the electric travel mode to the hybrid travel mode, the internal combustion engine VM is activated and the rotational speed of the internal combustion engine VM and of the electric motor P1 is approximated to the rotational speed of the electric motor P2. The clutch KM is then activated and the torque of the electric motor P2 is reduced to the same degree as the torque of the internal combustion engine VM and that of the electric motor P1 are increased.

When there is a change from the hybrid travel mode to the electric travel mode, the torque of the internal combustion engine VM and of the electric motor P1 is reduced to zero and the torque of the electric motor P2 is increased at the same ratio until the electric motor P2 generates the entire drive torque. The clutch KM is then firstly deactivated, and then the internal combustion engine VM and the electric motor P1 are deactivated.

When there is a change from the serial travel mode to the hybrid operating mode, the rotational speed of the internal combustion engine VM and the electric motor P1 are approximated to the rotational speed of the electric motor P2. The clutch KM is then activated and the torque of the electric motor P2 is reduced to the same degree as the torque of the internal combustion engine VM and of the electric motor P1 is increased.

When there is a change from the hybrid travel mode into the serial travel mode, the torque of the internal combustion engine VM and of the electric motor P1 is reduced to zero and the torque of the electric motor P2 is increased to the same degree until the electric motor P2 generates the entire drive torque. The clutch KM is then deactivated and the electric motor P1 is driven by the internal combustion engine VM in the generator operating mode.

When there is a change from the internal combustion engine travel mode to the hybrid travel mode, the electric motor P2 is approximated to the corresponding rotational speed of the internal combustion engine VM and of the electric motor P1. The clutch KE is then activated.

When there is a change from the hybrid travel mode to the internal combustion engine travel mode, the torque of the electric motor P2 is reduced to zero and the clutch KE is then deactivated. The entire drive torque is generated by the internal combustion engine VM and the electric motor P1, and the electric motor P2 is deactivated.

When there is a change from the internal combustion engine travel mode to the CVT1 travel mode or CVT2 travel mode, a rotational speed of the electric motor P2 is set corresponding to the transmission ratio of the momentarily engaged gear speed in the internal combustion engine travel mode after the switchover into the CVT1 travel mode or CVT2 travel mode. The torque of the internal combustion engine VM and of the electric motor P1 is set in such a way that the power at the output in addition to the power of the electric motor P2 corresponds to the power in the internal combustion engine travel mode. The clutch KG is then activated.

When there is a change from the CVT1 travel mode or CVT2 travel mode to the internal combustion engine travel mode, the rotational speed of the electric motor P2 is set corresponding to the transmission ratio of the desired gear speed after the switchover into the internal combustion engine travel mode as a function of the rotational speed of the internal combustion engine VM or of the electric motor P1 and the output rotational speed. The torque of the internal combustion engine VM and of the electric motor P1 is set to the torque which is required at the output. The clutch KG and then the electric motor P2 are then firstly deactivated.

In the stationary state of the vehicle, the clutches KM, KE and KG and the electric motors P1 and P2 are deactivated.

Between the stationary state of the vehicle with the internal combustion engine VM deactivated and the electric travel mode a change takes place by activating or deactivating the clutch KE and corresponding energization of the electric motor P2.

Between the stationary state of the vehicle with the internal combustion engine VM activated and the serial travel mode a change takes place by activating or deactivating the clutch KE, in which case the electric motor P1 is driven in the generator operating mode by the internal combustion engine VM, and the electric motor P2 either supplies a drive torque or is also operated in the generator operating mode.

Between the stationary state of the vehicle with the internal combustion engine VM activated and the hybrid travel mode a change takes place by activating or deactivating the clutches KE and KM, in which case the drive torques of the internal combustion engine VM are superimposed by means of the first power branch, and those of the electric motor P2 are superimposed by means of the second power branch. The electric motors P1 and P2 can supply a drive torque or be operated in the generator operating mode.

Between the stationary state of the vehicle with the internal combustion engine VM activated and the internal combustion engine travel mode a change takes place by activating or deactivating the clutch KM, in which case the internal combustion engine VM supplies a drive torque and the electric motor P1 also supplies a drive torque or is operated in the generator operating mode.

What is claimed is:

1. A method of controlling the operating mode of a motor vehicle with hybrid drive, wherein the operating mode is defined by a plurality of drive types including internal combustion engine drive, electromotive drive and mixed drive, wherein the selection of the operating mode is limited and dependent on a momentary operating mode permitting only specific changes between the operating modes.

2. The method as claimed in claim 1, wherein the vehicle has at least the following operating modes:
an electric travel mode in which the vehicle is driven by an electric motor (P1, P2) and the internal combustion engine (VM) is deactivated;
a serial travel mode in which the vehicle is driven by an electric motor (P1, P2) and the internal combustion engine (VM) drives a second electric motor (P2, P1) which is operated as a generator;
a hybrid travel mode in which the vehicle is driven by at least one electric motor (P1, P2) and the internal combustion engine (VM); and
an internal combustion engine travel mode in which the vehicle is driven by the internal combustion engine (VM) and the internal combustion engine (VM) can drive an electric motor (P1, P2) which is operated as a generator.

3. The method as claimed in claim 2, wherein only changes between the following operating modes are made possible:
a serial travel mode and electric travel mode,
a serial travel mode and hybrid travel mode,
a electric travel mode and hybrid travel mode, and
a hybrid travel mode and internal combustion engine travel mode.

4. The method as claimed in claim 2, wherein the vehicle has a CVT travel mode in which the vehicle is driven by at least one electric motor (P1, P2) and by the internal combustion engine (VM) via an infinitely variable transmission, as an additional operating mode.

5. The method as claimed in claim 4, wherein, in addition, a change between internal combustion engine travel mode and CVT travel mode is made possible.

6. The method as claimed in claim 4, wherein for different driving ranges the vehicle has a plurality of CVT travel modes in which the vehicle is driven by at least one electric motor (P1, P2) and the internal combustion engine (VM) via an infinitely variable transmission.

7. The method as claimed in claim 6, wherein, in addition, changes between the internal combustion engine travel mode and the various CVT travel modes are made possible.

8. The method as claimed in claim 7, wherein, in addition, changes between the various CVT travel modes are made possible.

9. The method as claimed in claim 1, wherein, in addition, a change between a stationary state of the vehicle with the internal combustion engine (VM) deactivated and an electric travel mode is made possible.

10. The method as claimed in claim 1, wherein, in addition, changes between a stationary state of the vehicle with the internal combustion engine (VM) activated and a serial travel mode, a hybrid travel mode and internal combustion engine travel mode are made possible.

11. The method as claimed in claim 1, wherein the change between operating modes takes place without hysteresis.

12. A control device for of a motor vehicle with hybrid drive, wherein the operating mode is defined by a plurality of drive types including an internal combustion engine drive, an electromotive drive and a mixed drive, and the selection of the operating mode is limited and dependent on a momentary operating mode permitting only specific changes between the operating modes, said control device including means for changing between the following operating modes:
a serial travel mode and electric travel mode,
a serial travel mode and hybrid travel mode,
a electric travel mode and hybrid travel mode, and
a hybrid travel mode and internal combustion engine travel mode.

13. The control device as claimed in claim 12, wherein, additionally, means are provided for changing between internal combustion engine travel mode and CVT travel mode.

14. The control device as claimed in claim 12, wherein, additionally, means are provided for changing between internal combustion engine travel mode and the various CVT travel modes.

15. The control device as claimed in claim 12, wherein, additionally, means are provided for changing between the various CVT travel modes.

16. The control device as claimed in claim 12, wherein, additionally, means are provided for changing between the stationary state of the vehicle with the internal combustion engine (VM) deactivated and electric travel mode.

17. The control device as claimed in claim 12, wherein, additionally, means are provided for changing between the stationary state of the vehicle with the internal combustion engine (VM) activated and serial travel mode, hybrid travel mode and internal combustion engine travel mode.

18. A motor vehicle with hybrid drive and a control device for carrying out a method as claimed in claim 1.
